(19) United States
(12) Patent Application Publication
(10) Pub. No.: US 2007/0287571 A1
(43) Pub. Date: Dec. 13, 2007

(54) Driving Mechanism for Garden Machine

(76) Inventor: Hui-Chung Li, Taoyuan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/750,379

(22) Filed: May 18, 2007

(30) Foreign Application Priority Data
Jun. 9, 2006 (TW) 95210028

(51) Int. Cl. F16H 48/10

(52) U.S. Cl. 475/248

(57) ABSTRACT

A driving mechanism for a garden machine includes a ring gear having a plurality of peripheral teeth on an inner periphery thereof. An input shaft includes a first end fixed to the ring gear to turn therewith and a second end coupled with a gear train in a gearbox of the garden machine. A motor is mounted to an input side of the gearbox and includes an output shaft having a driving gear fixed thereon. The driving gear meshes with the peripheral teeth of the ring gear.

### BACKGROUND OF THE INVENTION

1. Field of the Invention

The present invention relates to a driving mechanism for a garden machine. More particularly, the present invention relates to an electric driving mechanism for a garden cutting machine.

2. Description of the Related Art

A garden cutting machine generally includes a body portion to be held by a user and a pair of cutters driven by the body portion to proceed with cutting operation. The cutters have a considerable length and move relative to each other for cutting purposes. Rotary notion of the transmission mechanism in the body portion is converted into reciprocating movement of the cutters, and a gearbox is required for receiving the members for carrying out such conversion. An engine or motor is utilized as the main power source for driving the transmission mechanism in the body portion. However, conventional transmission mechanism in the body portion is complicated and bulky, is difficult to assemble and detach, and cannot provide efficient transmission

### SUMMARY OF THE INVENTION

An objective of the present invention is to provide a driving mechanism for a garden machine that can be driven electrically to effectively drive the cutters for proceeding with cutting operation.

Another objective of the present invention is to provide a driving mechanism for a garden machine that is simplified in structure and easy to assembly.

A further objective of the present invention is to provide a driving mechanism for a garden machine that is durable and has a low cost.

A driving mechanism for a garden machine according to the preferred teachings of the present invention includes a ring gear having a plurality of peripheral teeth on an inner periphery thereof. An input shaft includes a first end fixed to the ring gear to turn therewith and a second end coupled with a gear train in a gearbox of the garden machine. A motor is mounted to an input side of the gearbox and includes an output shaft having a driving gear fixed thereon. The driving gear meshes with the peripheral teeth of the ring gear.

Other objectives, advantages, and novel features of the invention will become more apparent from the following detailed description when taken in conjunction with the accompanying drawings.

### BRIEF DESCRIPTION OF THE DRAWINGS

FIG. 1 shows a side view of a garden cutting machine with a driving mechanism according to preferred teachings of the present invention.

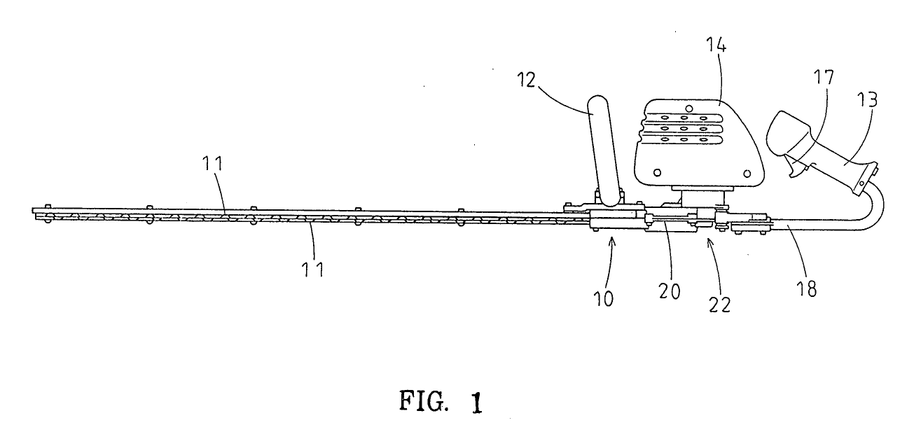

FIG. 2 shows a partly-cutaway perspective view of the driving mechanism of FIG. 1.

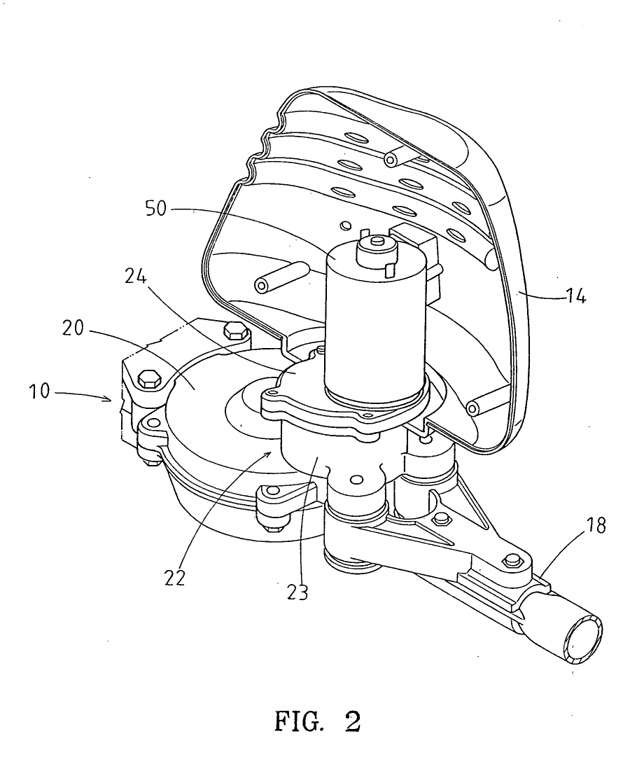

FIG. 3 shows an enlarged view of a portion of the garden cutting machine of FIG. 1.

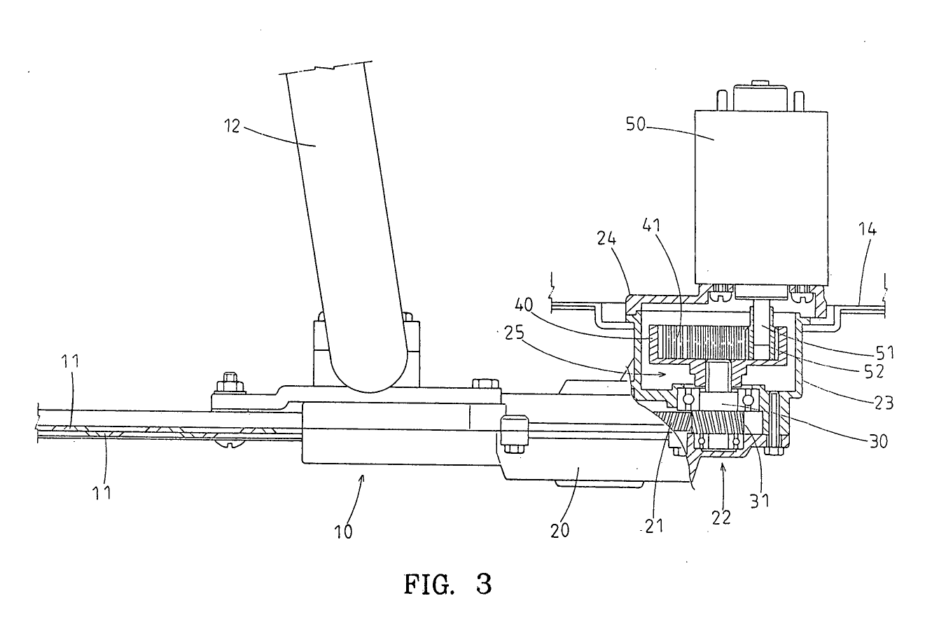

FIG. 4 shows an exploded perspective of a portion of the driving mechanism of FIG. 2.

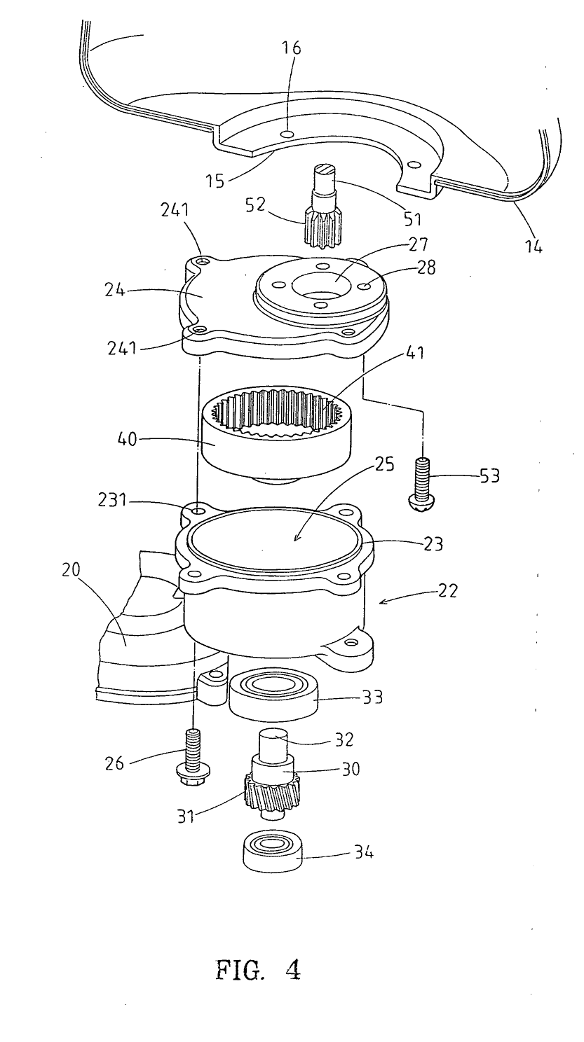

FIG. 5 shows a partly sectioned side view of the driving mechanism of FIG. 2.

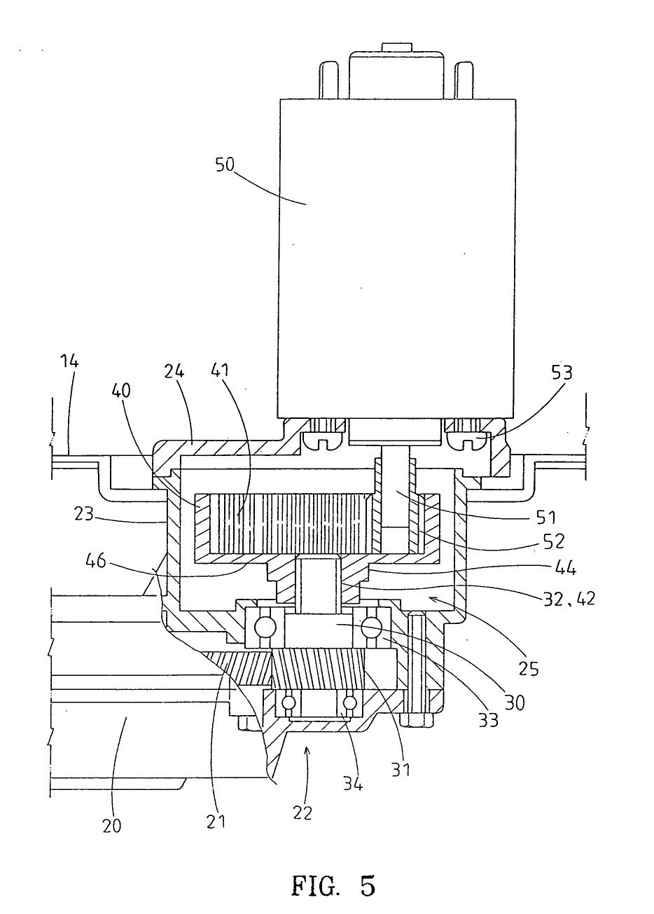

### DETAILED DESCRIPTION OF THE PREFERRED EMBODIMENT

A driving mechanism according to preferred teachings of the present invention is shown in the drawings and generally utilized in a garden machine, particularly a garden cutting machine. In the example shown, the garden cutting machine includes a body 10 to which a gearbox 20 is mounted, a pair of handles 12 in front of the gearbox 20, a connecting rod 18 extending rearward from the gearbox 20, a pair of cutters 11 extending forward from the body 10, a rear handle 13 mounted on a rear end of the connecting rod 18, and a switch 17 on the rear handle 13 for controlling horizontal reciprocating movement of the cutters 11. The gearbox 20 includes an input side 22 on which the driving mechanism is mounted.

In the preferred form shown, the driving mechanism includes a motor 50 mounted on the input side 22 of the gearbox 20 and driven by an internal or external power source (not shown). The motor 50 has an output shaft 51 on which a driving gear 52 is fixed. The driving mechanism further includes a ring gear 40 having a plurality of peripheral teeth 41 on an inner periphery thereof and meshed with the driving gear 52. Thus, the ring gear 40 is turned when the output shaft 51 turns. A hub 44 extends from an end wall 46 of the ring gear 40 in a direction parallel to a longitudinal axis of the ring gear 40 and includes a hole 42. An input shaft 30 includes an end 32 fixed in the hole 42 of the hub 44. Thus, the input shaft 30 and the ring gear 40 turns jointly. A gear 31 is fixed on the other end of the input shaft 30 and meshes with a gear train 21 mounted in the gearbox 20. The gear train 21 is coupled with the cutters 11 such that rotational movement of the gear 31 is converted into reciprocating movement of the cutters 11 for proceeding with cutting operation.

In the preferred form shown, the motor 50 is housed in a housing including two plastic housing halves 14 each having a semi-circular wall in which a plurality of holes 16 are defined. The semi-circular walls of the housing halves 14 together define an opening 15 through which the output shaft 51 extends. A hollow casing 23 is mounted to the input side 22 of the gearbox 20 and includes an upper opening 23. A cover 24 is mounted on top of the hollow casing 23 to define a compartment 25 for rotatably receiving the ring gear 40. Bolts 26 are extended through the holes 16 of the housing 14 and holes 231 in the hollow casing 23 into screw holes 241 in the cover 24. The end 32 of the input shaft 30 is extended upward into the compartment 25 and fixed in the hole 42 of the ring gear 40. Bearings 33 and 34 are provided to allow stable rotation of the gear 31 that meshes with the gear train 21. The motor 50 is mounted on top of the cover 24 by extending bolts 53 through holes 28 in the cover 24 into the motor housing (not labeled), with the output shaft 51 extending through a through-hole 27 of the cover 24 into the compartment 25 of the hollow casing 23 and with the driving gear 52 meshing with the peripheral teeth 41 of the ring gear 40. The ring gear 40 and the input shaft 30 are mounted in a central area of the hollow casing 23 on the input side 22 of the gearbox 20. The output shaft 51 of the motor 50 is in an eccentric position of the cover 24.

The driving mechanism for a garden machine according to the preferred teachings of the present invention can be electrically driven to effectively drive the cutters 11 for proceeding with cutting operation. Furthermore, the driving mechanism for a garden machine according to the preferred teachings of the present invention is simplified in structure, easy to assembly and durable and has a low cost.

Although a specific embodiment has been illustrated and described, numerous modifications and variations are still possible without departing from the teachings of the invention. The scope of the invention is limited by the accompanying claims.

1. A driving mechanism for a garden machine, the garden machine including a gearbox having a gear train mounted therein and meshed with two cutters, the driving mechanism comprising:
a ring gear including a plurality of peripheral teeth on an inner periphery thereof;
an input shaft including a first end fixed to the ring gear to turn therewith, with the input shaft further including a second end coupled with the gear train; and
a motor mounted to an input side of the gearbox and including an output shaft having a driving gear fixed thereon, with the driving gear meshing with the peripheral teeth of the ring gear.

2. The driving mechanism for a garden machine as claimed in claim 1, with the ring gear including an end wall and a hub extending from the end wall and parallel to a longitudinal axis of the ring gear, with the first end of the input shaft being fixed in the hub, with a gear being fixed on the second end of the input shaft and meshed with the gear train.

3. The driving mechanism for a garden machine as claimed in claim 2, further including a hollow casing mounted on the input side of the gearbox and having an upper opening; and a cover fixed on top of the hollow casing to define a compartment in which the ring gear is received, with the cover including a through-hole, with the motor being mounted on top of the cover, and with the output shaft and the driving gear of the motor extending through the through-hole into the compartment.

4. The driving mechanism for a garden machine as claimed in claim 3, with the ring gear and the input shaft being located in a central area of the hollow casing, with the output shaft being located in an eccentric position of the cover, further including a plurality of bolts extending through the cover and fixed to the motor.
